(19) United States
(12) Patent Application Publication
(10) Pub. No.: US 2009/0160625 A1
(43) Pub. Date: Jun. 25, 2009

(54) COMMUNICATION APPARATUS, NON-CONTACT TYPE IC CARD, SIGNAL SELECTION METHOD AND PROGRAM PRODUCT

(75) Inventor: Yoichi MIYAGAWA, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: FeliCa Networks, Inc., Shinagawa-ku (JP)

(21) Appl. No.: 12/336,890

(22) Filed: Dec. 17, 2008

(30) Foreign Application Priority Data
Dec. 21, 2007 (JP) 2007-331063

(51) Int. Cl. H04Q 5/22

(52) U.S. Cl. 340/10.51; 340/10.1

(57) ABSTRACT

A communication apparatus receiving a signal via a non-contact communication is provided. The communication apparatus includes a plurality of demodulation mechanisms demodulating in parallel multiple modulated signals obtained by splitting a received signal, a characteristics comparison mechanism comparing with each other, in a detection phase of synchronous codes of output signals output from the plurality of the demodulation mechanisms, the characteristics of the output signals, and a signal selection mechanism selecting, in accordance with the comparison result by the characteristics comparison mechanism, the output signal having comparatively good characteristics.

### CROSS REFERENCES TO RELATED APPLICATIONS

The present application contains subjected matter related to Japanese Patent Application JP 2007-331063 filed in the Japan Patent Office on Dec. 21, 2007, the entire contents of which being incorporated herein by reference.

### BACKGROUND OF THE INVENTION

1. Field of the Invention

The present invention relates to a communication apparatus, a non-contact type IC card, a signal selection method and a program product.

2. Description of the Related Art

In recent years, mobile phones or a portable information terminal provided with a non-contact type IC (Integrated Circuit) card or a non-contact type IC chip, or a communication apparatus, information processor and the like provided with a read/write function of communicating with a non-contact type IC card in a non-contact manner has become widespread. Hereunder, these apparatuses or devices will be called non-contact communication apparatuses. The reader/writer and the non-contact type IC card can perform a near field communication between each other by using a carrier of a specific frequency (for example, 13.56 MHz). For example, when a command for making the non-contact type IC card execute a predetermined process is transmitted from the reader/writer, the non-contact type IC card executes the process in accordance with the received command and transmits back the execution result as a response signal. At this time, the reader/writer and the non-contact type IC card transmit the command or the response signal by using a modulation technology called load modulation for modulating a carrier by changing the load on an antenna in accordance with transmission data.

Note here that the non-contact communication apparatus is configured by, for example, an RF communication chip for realizing a non-contact communication as described above and a secure chip capable of securely storing data. For example, JP-A-2007-34973 discloses a technology relating to a non-contact type IC card configured by the RF communication chip for realizing a proximity communication (so-called “non-contact communication”) and a Secure Application Module (SAM) chip in which data is securely stored. In the document, a technology of realizing an error detection based on a check code of a packet received from the reader/writer is described.

### SUMMARY OF THE INVENTION

For example, when splitting a modulated signal received from the reader/writer and demodulating data with a plurality of demodulation circuits, or when obtaining a modulated signal originating from the reader/writer through multiple routes and demodulating data with a plurality of demodulation circuits, by applying the technology described above on each demodulated data, high-quality demodulated data can be selected based on the result of the error detection. However, as recognized by the present inventors, with the technology described above, since the error detection is performed based on the check code located at the posterior section of the packet, the error detection takes time and a process delay occurs. Further, at the time of error detection, multiple demodulated data are temporarily stored in the SAM chip, and thus, the memory capacity required for the error detection becomes large.

Accordingly, the present invention has been made in view of the foregoing, and it is desirable to provide a new and improved communication apparatus, a non-contact type IC card, a signal selection method and a program enabling the selection of high-quality data in a detection phase of synchronous codes included in signals output from a plurality of demodulation sections.

In order to solve the above issue, according to an embodiment of the present invention, there is provided a communication apparatus receiving a signal transmitted via a non-contact communication. The communication apparatus includes a plurality of demodulation sections demodulating in parallel multiple modulated signals obtained from the signal, a characteristics comparing section comparing with each other, in the detection phase of synchronous codes of output signals output from the plurality of the demodulation sections, the characteristics of the output signals, and a signal selecting section selecting, in accordance with the comparison result by the characteristics comparing section, the output signal having comparatively good characteristics.

Further, the characteristics comparing section may have an amplitude comparing section comparing the amplitude of the output signals as one characteristic and a Duty comparing section comparing the Duty ratio of the output signals as another characteristic. Also, the signal selecting section may be configured to select, in accordance with the comparison result by the amplitude comparing section, the output signal with comparatively large amplitude or to select, in accordance with the comparison result by the Duty comparing section, the output signal with the Duty ratio comparatively near a predetermined value.

Further, the signal selecting section may be configured to determine whether to select the output signal in accordance with the comparison result by the amplitude comparing section or to select the output signal in accordance with the comparison result by the Duty comparing section based on a predetermined priority information for specifying the comparison result to be preferentially referred to between the comparison result by the amplitude comparing section and the comparison result by the Duty comparing section.

Further, the communication apparatus may include a digital converting section converting the output signal output from the demodulation section to a digital signal and a waveform shaping section shaping the waveform of the digital signal output from the digital converting section. Also, the amplitude comparing section may be configured to compare with each other the output signals output from the plurality of the demodulation sections. Further, the Duty comparing section may be configured to compare with each other the digital signal originating from each of the demodulation sections output from the waveform shaping section.

Further, the characteristics comparing section may be configured to compare the amplitude of the output signals as the characteristics. Also, the signal selecting section may be configured to select, in accordance with the comparison result by the characteristics comparing section, the output signal with large amplitude.

Further, the characteristics comparing section may be configured to compare the Duty ratio of the output signals as the characteristics. Also, the signal selecting section may be configured to select, in accordance with the comparison result by the characteristics comparing section, the output signal whose Duty ratio is comparatively near a predetermined value.

Further, the communication apparatus may be a non-contact type IC card having a secure chip in which information is securely stored and a communication chip that executes the process of storing information in or reading information from the secure chip in accordance with a predetermined command obtained by using non-contact communication or a reader/writer transmitting the predetermined command to a communication device that has the function of the non-contact type IC card or receiving a response signal transmitted in response to the predetermined command.

Further, in order to solve the above issue, according to another embodiment of the present invention, there is provided a non-contact type IC card having a secure chip in which information is securely stored and a communication chip that receives from a reader/writer a command for executing the process of storing information in or reading information from the secure chip and executes the process of storing information in or reading information from the secure chip in accordance with the command. The non-contact type IC card includes a plurality of demodulation sections demodulating in parallel multiple modulated signals obtained from a signal transmitted from the reader/writer, a characteristics comparing section comparing with each other, in a detection phase of synchronous codes of output signals output from the plurality of the demodulation sections, the characteristics of the output signals, and a signal selecting section selecting, in accordance with the comparison result by the characteristics comparing section, the output signal having comparatively good characteristics.

Further, the characteristics comparing section may have an amplitude comparing section comparing the amplitude of the output signals as one characteristic and a Duty comparing section comparing the Duty ratio of the output signals as another characteristic. Also, the signal selecting section may be configured to select, in accordance with the comparison result by the amplitude comparing section, the output signal with comparatively large amplitude or to select, in accordance with the comparison result by the Duty comparing section, the output signal with the Duty ratio comparatively near a predetermined value.

Further, the signal selecting section may be configured to determine whether to select the output signal in accordance with the comparison result by the amplitude comparing section or to select the output signal in accordance with the comparison result by the Duty comparing section based on a predetermined priority information for specifying the comparison result to be preferentially referred to between the comparison result by the amplitude comparing section and the comparison result by the Duty comparing section.

Further, the non-contact type IC card may include a digital converting section converting the output signal output from the demodulation section to a digital signal and a waveform shaping section shaping the waveform of the digital signal output from the digital converting section. Also, the amplitude comparing section may be configured to compare with each other the output signals output from the plurality of the demodulation sections. Further, the Duty comparing section may be configured to compare with each other the digital signal originating from each of the demodulation sections output from the waveform shaping section.

Further, the characteristics comparing section may be configured to compare the amplitude of the output signals as the characteristics. Also, the signal selecting section may be configured to select, in accordance with the comparison result by the characteristics comparing section, the output signal with large amplitude.

Further, the characteristics comparing section may be configured to compare the Duty ratio of the output signals as the characteristics. Also, the signal selecting section may be configured to select, in accordance with the comparison result by the characteristics comparing section, the output signal whose Duty ratio is comparatively near a predetermined value.

Further, in order to solve the above issue, according to another embodiment of the present invention, there is provided a method of selecting a signal including a demodulating step of demodulating in parallel, by a plurality of demodulation sections, multiple modulated signals obtained from a signal transmitted in a non-contact communication, a characteristics comparing step of comparing with each other, in a detection phase of synchronous codes of output signals output from the plurality of the demodulation sections, the characteristics of the output signals, and a signal selecting step of selecting, in accordance with the comparison result of the characteristics comparing step, the output signal with comparatively good characteristics.

Further, in order to solve the above issue, according to another embodiment of the present invention, there is provided a program for making a computer realize a demodulating function of demodulating in parallel multiple modulated signals obtained from a signal transmitted in a non-contact communication, a characteristics comparing function of comparing with each other, in a detection phase of synchronous codes of output signals demodulated and output by the demodulating function, the characteristics of the output signals, and a signal selecting function of selecting, in accordance with the comparison result by the characteristics comparing function, the output signal having comparatively good characteristics. Further, a recording medium in which the program is recorded may also be provided.

By applying the configuration described above, it becomes possible to execute quality judgment of output signals in a detection phase of synchronous codes included in the output signals demodulated by a plurality of demodulation sections, and the quality of the output signals can be judged without waiting for an error judgment that is executed based on error information located in a section posterior to the synchronous codes. The judgment may be carried out on multiple modulated signals obtained by splitting a received signal, or on multiple modulated signals obtained from multiple antennas when a signal is received by the multiple antennas. Of course, it is not limited to such and the judgment may be carried out on multiple modulated signals obtained from a signal based on other methods.

According to the embodiments of the present invention described above, it becomes possible to select high-quality data in the detection phase of the synchronous codes included in signals output from a plurality of demodulation sections. As a result, since the quality of an output signal can be judged without waiting for the error judgment that is executed based on the error information located in the posterior section of the output signal, the quality judgment of the output signal can be realized in a shorter time.

### BRIEF DESCRIPTION OF THE DRAWINGS

FIG. 1 is an explanatory diagram showing a function configuration of a communication apparatus according to an embodiment of the present invention.

FIG. 2 is an explanatory diagram showing a structure example of communication data according to the embodiment.

FIG. 3 is an explanatory diagram showing a flow of a data selection method according to the embodiment.

FIG. 4 is an explanatory diagram showing a configuration example of a non-contact communication apparatus.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Here, before describing in detail the preferred embodiment according to the present invention, to promote understanding of the technical concept described hereunder, its outline will be briefly described.

The technology according to the embodiment described hereunder relates to a communication apparatus having a plurality of demodulation sections. More specifically, the technology has its characteristics in that it is configured to select a baseband signal to be adopted in the detection phase of synchronous codes included in baseband signals by using a quality comparing circuit for comparing the quality of the baseband signals output from the plurality of the demodulation sections. As the communication apparatus having the plurality of the demodulation sections, a non-contact type IC card capable of non-contact communication on both sides and the like may be conceived, for example. As another example, a reader/writer and the like prepared for a phase-inverted null may be conceived. Note that the phase-inverted null is a phenomenon where, at the time of non-contact communication between a non-contact type IC card and the reader writer, an area where communication is not possible (so-called null point) is generated by the magnetic coupling between the antennas of the non-contact type IC card and the reader/writer. To prevent this, a measure can be conceived of using multiple antennas, as the antenna of the reader/writer, that couple with the antenna of the non-contact type IC card in different levels. The technology to be described hereunder can also be applied to the reader/writer and the like to which the technology described above is applied.

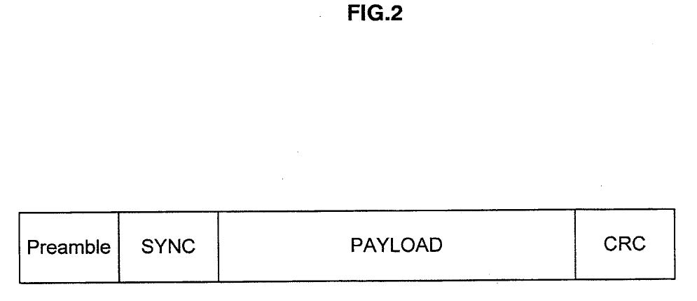

The communication apparatus as described above should be provided with a signal selecting function of selecting any of the baseband signals output from the plurality of the demodulation circuits. Particularly, a signal selecting function of selecting a baseband signal from which correct data is reproduced is desired. For example, as a technology for detecting an error of a signal, a technology of performing the error detection based on an error detection code (CRC; Cyclic Redundancy Code) included in a packet is known. However, the error detection code is located at the end section of the packet as shown in FIG. 2 and the entire packet has to be temporarily held for the error detection. Thereby, when the error detection technology described above is applied to the communication apparatus having the plurality of the demodulation circuits, it becomes necessary to include a buffer memory for storing packet data for all the demodulation circuits. That is, a larger memory capacity becomes necessary.

Here, with reference to FIG. 2, a data structure of a packet will be briefly described. FIG. 2 is an explanatory diagram showing the data structure of a packet.

As shown in FIG. 2, a packet is configured by, for example, a preamble, a synchronization code (SYNC; SYNC code), a data portion (Data) and a CRC (Cyclic Redundancy Code). The preamble is used for synchronization with a reference clock. The synchronization code is located at the anterior section of the data portion and is used for detecting the beginning of data. The payload is the body of the data and is data including process command and the like to be executed by a data processing section and the like described later. The CRC is a code used for the process of error detection called a cyclic redundancy check. The validity of the data is verified by the process of the error detection. The communication apparatus described above transmits/receives a packet having such data structure, for example.

Note here that in a case of the communication apparatus having an RF chip for non-contact communication and a secure chip for securely storing data as the non-contact type IC card described above, data is transmitted to the secure chip after the RF chip takes in the packet until the location of the error detection code. Accordingly, as can be expected from the data structure described above, a processing delay is caused. Thus, the present inventor has come up with the technology of selecting a high-quality baseband signal upon detecting a synchronous code of a packet.

Note that, when selecting a signal upon detecting the SYNC code, it is not desirable to simply weight each demodulation circuit since it may decrease the demodulation success rate of the overall system. For example, assume a case where a weight is set for two demodulation circuits to “first demodulation circuit>second demodulation circuit”. In this case, where the success rate of demodulation until the synchronous code of a baseband signal output from the first demodulation circuit is 50%, where the demodulation is carried out with success until the end, and the demodulation success rate of the second demodulation circuit is 100%, even though the demodulation success rate of the second demodulation circuit is 100%, the demodulation success rate of the overall system is 75%. This applies to a case where the quality of data is “first demodulation circuit<second demodulation circuit” but the first demodulation circuit manages to obtain the data. The technology which will be described in detail in the following was conceived in view of the above-mentioned issues.

An embodiment of the present invention will be described. The present embodiment relates to a communication apparatus having a plurality of demodulation circuits and has its characteristics in the technology of selecting a high-quality baseband signal in the detection phase of a synchronous code by comparing the amplitude or the Duty ratio of the baseband signals output from the plurality of the demodulation circuits. Incidentally, the technology can be applied to, for example, a non-contact type IC card or a reader/writer, or a portable communication device or an information processor and the like with one or both of the functions of the non-contact type IC card and the reader/writer.

### Function Configuration of Communication Apparatus 100

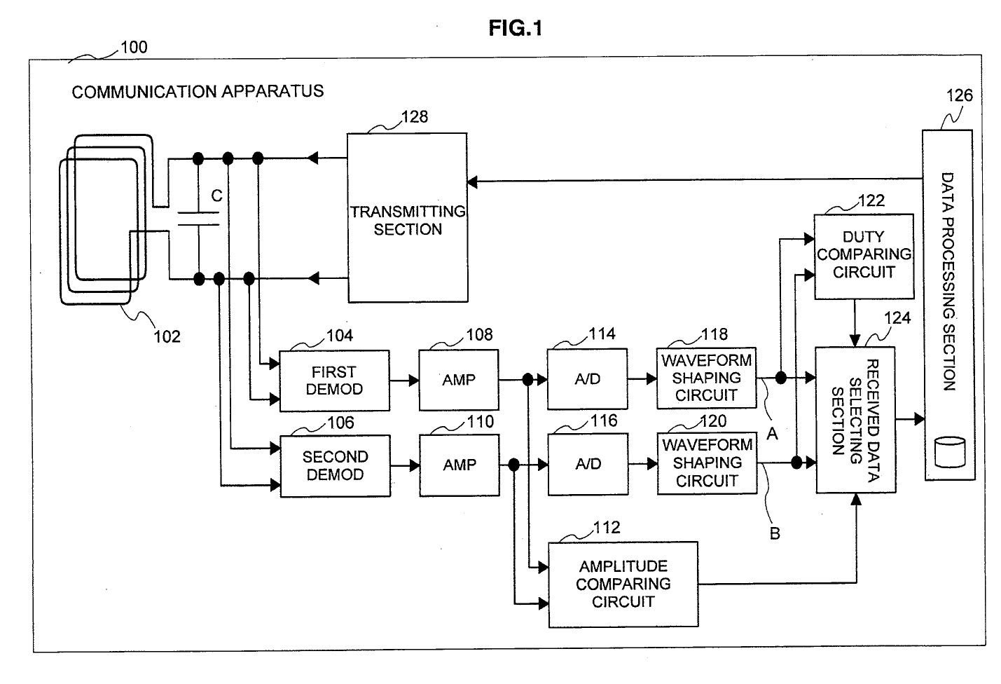

First, with reference to FIG. 1, a function configuration of a communication apparatus 100 according to the present embodiment will be described. FIG. 1 is an explanatory diagram showing the function configuration of the communication apparatus 100 according to the present embodiment.

As shown in FIG. 1, the communication apparatus 100 is mainly configured by an antenna 102, a first demodulator 104, a second demodulator 106, amplifiers 108, 110, an amplitude comparing circuit 112, analog-digital converters 114, 116, waveform shaping circuits 118, 120, a Duty comparing circuit 122, a received data selecting section 124, a data processing section 126 and a transmitting section 128.

Incidentally, the first demodulator 104 and the second demodulator 106 are examples of a demodulation section. The amplitude comparing circuit 112 and the Duty comparing circuit 122 are examples of a characteristics comparing section. Further, the amplitude comparing circuit 112 is an example of an amplitude comparing section. The Duty comparing circuit 122 is an example of a Duty comparing section. Further, the received data selecting section 124 is an example of a signal selecting section. The analog-digital converters 114, 116 are examples of a digital converting section. The waveform shaping circuits 118, 120 are examples of a waveform shaping section.

As shown in FIG. 1, a modulated signal received via the antenna 102 is split and the obtained signals are input to the first demodulator 104 and the second demodulator 106, respectively. In the first demodulator 104 and the second demodulator 106, analog baseband signals are demodulated from the modulated signals based on a predetermined modulation scheme. The analog baseband signal demodulated by the first demodulator 104 is input to the amplifier 108 and is amplified. Similarly, the analog baseband signal demodulated by the second demodulator 106 is input to the amplifier 110 and is amplified. Incidentally, as the predetermined demodulation scheme, a demodulation scheme such as the amplitude shift keying (ASK) demodulation is used.

The analog baseband signal amplified by the amplifier 108 is split, and one of the obtained signals is input to the analog-digital converter 114 and the other is input to the amplitude comparing circuit 112. Similarly, the analog baseband signal amplified by the amplifier 110 is split, and one of the obtained signals is input to the analog-digital converter 116 and the other is input to the amplitude comparing circuit 112. In the amplitude comparing circuit 112, the amplitude of the analog baseband signals amplified by the amplifiers 108, 110 are compared, and as the comparison result, the information indicating analog baseband signal with larger amplitude is input to the received data selecting section 124. Note that an envelope detection circuit, a sample/hold circuit and the like are used for the amplitude comparing circuit 112, for example.

In the analog-digital converter 114, the analog baseband signal amplified by the amplifier 108 is converted to a digital baseband signal. Similarly, in the analog-digital converter 116, the analog baseband signal amplified by the amplifier 110 is converted to a digital baseband signal. The digital baseband signal output from the analog-digital converter 114 is input to the waveform shaping circuit 118 and is waveform-shaped. Similarly, the digital baseband signal output from the analog-digital converter 116 is input to the waveform shaping circuit 120 and is waveform-shaped. The data waveform-shaped and output from the waveform shaping circuits 118, 120 is split, and one part of the obtained data is input to the Duty comparing circuit 122 and the other part is input to the received data selecting section 124. For the convenience of the explanation, the data output from the waveform shaping circuit 118 will be referred to as data A and the data output from the waveform shaping circuit 120 will be referred to as data B.

In the Duty comparing circuit 122, the Duty ratio of the input data A and data B are compared, and as the comparison result, the information of the data whose Duty ratio is nearer to 50% is input to the received data selecting section 124. The received data selecting section 124 selects data A or data B based on the comparison results output from the amplitude comparing circuit 112 and the Duty comparing circuit 122. Then, the received data selecting section 124 transmits the selected data to the data processing section 126. The data processing section 126 executes data processing based on the data selected by the received data selecting section 124. Further, when a response processing occurs as a result of the data processing, the data processing section 126 transmits to the transmitting section 128 response data along with a request to transmit a response signal. The transmitting section 128 transmits the response data via the antenna 102 in response to the request to respond obtained from the data processing section 126.

Incidentally, an integrating circuit may be used for the Duty comparing circuit 122 as with the analog method, or the Duty comparing circuit 122 may compare the Duty ratio by the method of counting the H (or L) periods by using a system clock as with the digital method. It should be noted here that the comparison of the Duty ratio is preferably executed by using data that is waveform-shaped by the waveform shaping circuits 118, 120 (for example, a digital phase-locked loop (DPLL) circuit and the like).

Heretofore, the function configuration of the communication apparatus 100 according to the present embodiment has been described. By applying the configuration described above, since the quality of the baseband signals can be judged in the detection phase of the synchronous codes included in the baseband signals output from the plurality of the demodulators, it becomes possible to perform signal selection process at a higher speed. As a result, improvement in the processing speed of the overall system can be expected. Further, the memory capacity for data cache required at the time of error detection can be reduced.

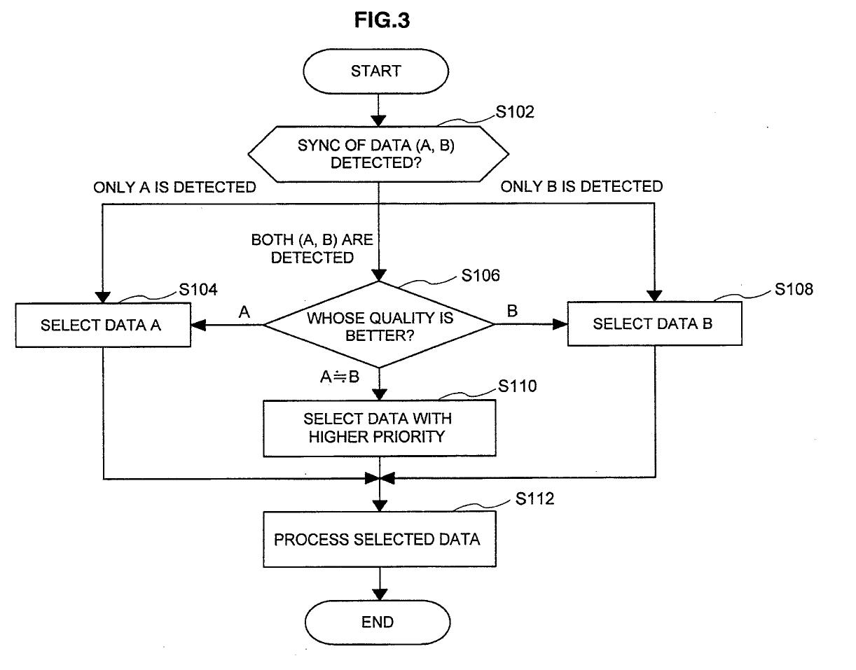

Next, with reference to FIG. 3, a data selection method of the received data selecting section 124 will be described in detail. FIG. 3 is an explanatory diagram showing a flow of the data selection method according to the present embodiment.

As shown in FIG. 3, the received data selecting section 124 judges whether the SYNC code of data A or data B is detected or not (S102). When only the SYNC code of data A is detected, the received data selecting section 124 proceeds to the processing of step S104. When only the SYNC code of data B is detected, the received data selecting section 124 proceeds to the processing of step S108. When both of the SYNC codes of data A and data B are detected, the received data selecting section 124 proceeds to the processing of step S106.

In step S104, the received data selecting section 124 selects data A and proceeds to the processing of step S112 (S104). Also, in step S108, the received data selecting section 124 selects data B and proceeds to the processing of step 112 (S108).

On the other hand, in case of step S106, the received data selecting section 124 refers to one or both of the comparison result by the amplitude comparing circuit 112 and the comparison result by the Duty comparing circuit 122 and selects data with comparatively high quality among the data A and data B (S106). When the quality of data A is better, the received data selecting section 124 proceeds to the processing of step S104. On the other hand, when the quality of data B is better, the received data selecting section 124 proceeds to the processing of step S108. Further, when the quality of data A and data B is about the same level, the received data selecting section 124 proceeds to the processing of step S110.

It should be noted here that, in step S106, there are two cases for the received data selecting section 124 to judge that the quality of data A and data B is about the same level. The first case is a case where the comparison result by the amplitude comparing circuit 112 and the comparison result by the duty comparing circuit 122 are contradictory. For example, it is a case where, according to the comparison result by the amplitude comparing circuit 112, the quality of data A is better and, according to the comparison result by the Duty comparing circuit, the quality of data B is better. The second case is a case where the quality of data A and data B can simply be assumed to be of the same level in a predetermined range. Thus, the content of the process for each case will be briefly described.

In step S110, the received data selecting section 124 selects data A or data B according to the priority ranking of the comparison result set beforehand (S110). For example, the received data selecting section 124 holds predetermined priority ranking information indicating the comparison result with higher priority among the comparison result by the amplitude comparing circuit 112 and the comparing result by the Duty comparing circuit 122 and selects data A or data B based on the predetermined priority ranking information. Incidentally, the priority ranking information is determined in accordance with the characteristics of the first demodulator 104 and the second demodulator 106. However, the priority ranking information may be determined based also on the characteristics of the amplifiers 108, 110. Or it may be determined based on a predetermined modulation scheme used in the first demodulator 104 and the second demodulator 106. By setting such priority ranking information, it becomes possible to perform the data selection process more suited to the characteristics of the communication apparatus 100.

In step S110, the received data selecting section 124 selects data A or data B according to the priority ranking of the comparison result set beforehand (S110). In the second case, a predetermined priority ranking information indicating which of data A and data B is to be selected is used. The priority ranking information is determined in such a manner as to select data corresponding to a stream with better characteristics when the characteristics of a stream corresponding to the output of the first demodulator 104 and the characteristics of a stream corresponding to the output of the second demodulator 106 are known beforehand. Here, the manufacturer of the communication apparatus 100 may arbitrary set the priority ranking.

When the processing of step S110 is completed, the received data selecting section 124 proceeds to the processing of step 112. In step S112, the received data selecting section 124 transmits the data selected in any one of steps S104, S108 and S110 to the data processing section 126 (S112) and ends the data selection process. Then, the data processing section 126 executes the processing of the data obtained from the received data selecting section 124.

Heretofore, the data selection method according to the present embodiment has been described. By applying the method described above, it becomes possible to judge the quality of data according to the characteristics of the demodulator and the like, and thus, a more appropriate data selection method is realized. More specifically, by comparing the quality of data on the analog side and the digital side, it is expected that it becomes possible to judge the quality of data more accurately.

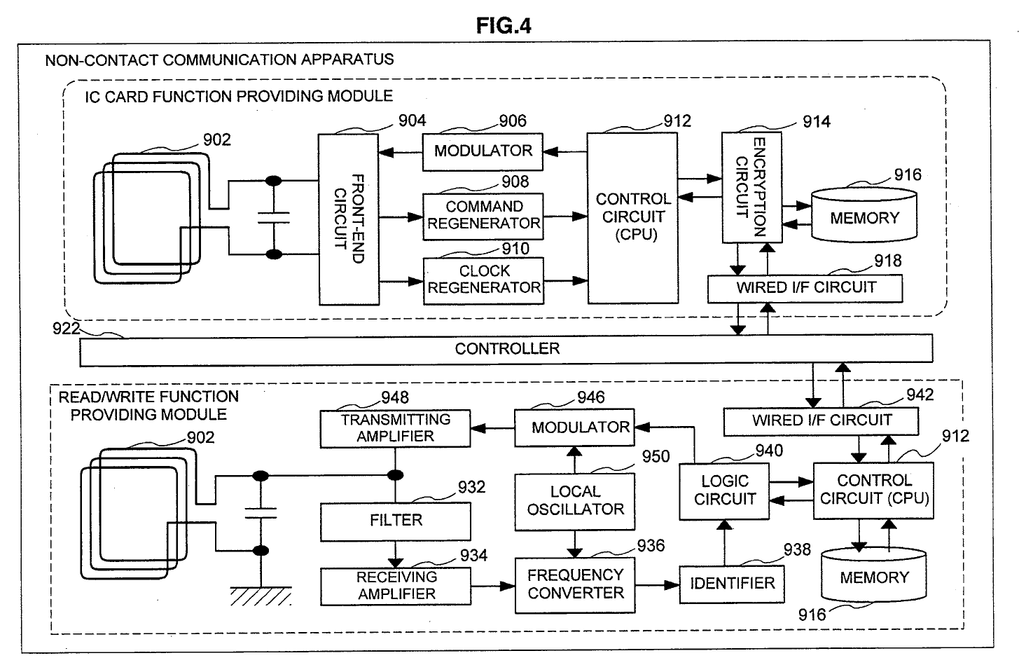

Here, with reference to FIG. 4, a configuration example of a non-contact communication apparatus capable of realizing the functions of the apparatus described above will be briefly described. FIG. 4 is an explanatory diagram showing the configuration example of the non-contact communication apparatus. Incidentally, it is possible to have the functions of the apparatus described above realized by using only a part of the structural elements of the non-contact communication apparatus. Further, the structural elements denoted with the same reference numerals may be configured in a single hardware unit.

As shown in FIG. 4, the non-contact communication apparatus is mainly configured by an IC card function providing module, a read/write function providing module and a controller 922.

The IC card function providing module is configured by, for example, an antenna 902, a front-end circuit 904, a modulator 906, a command regenerator 908, a clock regenerator 910, a control circuit 912, an encryption circuit 914, a memory 916 and a wired interface circuit 918.

The antenna 902 is configured by a loop antenna and receives command and power by magnetically coupling with the loop antenna of a reader/writer and. The front-end circuit 904 rectifies a carrier transmitted from the reader/writer and regenerates direct-current power. Further, the front-end circuit 904 frequency-divides the obtained carrier of 13.56 MHz and inputs the same to the command regenerator 908 and the clock regenerator 910. The command regenerator 908 regenerates a command from the input carrier and inputs the same to the control circuit 912. The clock regenerator 910 regenerates a clock for driving a logic circuit from the input carrier and inputs the same to the control circuit 912. Further, the front-end circuit 904 supplies the regenerated power to the control circuit 912 (CPU).

When power is supplied to all the circuits, the control circuit 912 drives each circuit according to the regenerated command. Note that the data output from the control circuit 912 is encrypted by the encryption circuit 914 and stored in the memory 916. Note that the memory 916 may be a storage device storing information magnetically, optically or magneto-optically, for example, or it may be a semiconductor storage device used as a ROM (Read Only Memory), a RAM (Random Access Memory) and the like.

On the other hand, when transmitting the encrypted data stored in the memory 916, the front-end circuit 904 changes the load impedance at the feeding point of the antenna 902 based on the encrypted data modulated by the modulator 906 and, in response to the change, changes the magnetic field induced by the antenna 902. With the change in the magnetic field, the current change flowing through the antenna of the reader/writer magnetically coupled is induced, and the encrypted data is transmitted.

Further, the control circuit 912 may be controlled by the controller 922 via the wired interface circuit 918. Further, it may be possible for the IC card function providing module to transmit/receive information to/from a read/write function providing module described later via an interface I/F (not shown) and to mutually control each other or perform control of one to the other.

The read/write function providing module is configured by, for example, an antenna 902, a filter 932, a receiving amplifier 934, a frequency converter 936, an identifier 938, a logic circuit 940, a control circuit 912, a memory 916, a wired interface circuit 942, a modulator 946, a local oscillator 950 and a transmitting amplifier 948.

The read/write function providing module provides command and supplies power by using the magnetic coupling with the non-contact type IC card and the like. The read/write function providing module, by the control of the control section 912 (CPU), supplies power to the non-contact type IC card and the like to activate it, and then, starts communication according to a predetermined transmission protocol. At this time, the read/write function providing module establishes a communication connection, performs the anti-collision processing, the authentication processing and the like.

The read/write function providing module generates a carrier by using the local oscillator 950. When transmitting information, first, the control circuit 912 reads data from the memory 916 and transmits the data to the logic circuit 940. Then, the modulator 946 modulates the carrier generated by the local oscillator 950 based on the signal output from the logic circuit 940. Further, the transmitting amplifier 948 amplifies the modulated wave output from the modulator 946 and transmits the wave via the antenna 902.

On the other hand, when receiving information, first, the modulated wave received via the antenna 902 is input to the receiving amplifier 934 after being passed through the filter 932. Then, the signal amplified by the receiving amplifier 934 is frequency-converted by the frequency converter 936 and is input to the logic circuit 940. Further, the signal output from the logic circuit 940 is stored in the memory 916 by the control circuit 912. Or, the signal is transmitted to the external controller 922 via the wired interface circuit 942.

Heretofore, the configuration example of the non-contact communication apparatus has been described. The non-contact communication apparatus may be a mobile phone, a portable information terminal, various communication devices, an information processor such as a personal computer, or a game machine, intelligent home appliances and the like, for example. Also, various devices with a part or all of the functions or structural elements of the non-contact communication apparatus described above are included in the technical scope of the embodiment described above. It is needless to say that a program making a computer realizes the function of each structural element or a recording medium in which such program is recorded is included in the technical scope of the embodiment described above.

It should be understood by those skilled in the art that various modifications, combinations, sub-combinations and alterations may occur depending on design and other factors insofar as they are within the scope of the appended claims or the equivalents thereof.

For example, in the description of the embodiment described above, the function configuration of the communication apparatus 100 having two demodulators is shown. However, the number of the demodulators is not limited to such. For example, three or more demodulators may be provided. In that case, signals output from each of the demodulators are compared in the amplitude comparing circuit 112, and further, the waveform-shaped signals are compared in the Duty comparing circuit 122, and in accordance with the comparison results, high-quality data is selected by the received data selecting section 124. Further, in the embodiment described above, the configuration is shown where a signal is selected in accordance with the comparison results output from the amplitude comparing circuit 112 and the Duty comparing circuit 122. However, the signal can be selected in accordance with either one of the comparison results. Or, the communication apparatus 100 may be formed to have only one of the comparing circuits.

What is claimed is:

1. A communication apparatus receiving a signal transmitted via a non-contact communication, comprising:
a plurality of demodulation mechanism that demonstrates in parallel multiple modulated signals obtained from the signal;
a characteristics comparison mechanism that comprises with each other, in a detection phase of synchronous codes of output signals output from the plurality of the demodulation mechanisms, the characteristics of the output signals; and
a signal selection mechanism that selects, in accordance with the comparison result by the characteristics comparison mechanism, the output signal having comparatively good characteristics.

2. The communication apparatus according to claim 1, wherein
the characteristics comparison mechanism comprising:
an amplitude comparison mechanism that comprises the amplitude of the output signals as one characteristic; and
a Duty comparison mechanism that comprises the Duty ratio of the output signals as another characteristic; and
the signal selection selects, in accordance with the comparison result by the amplitude comparison mechanism, the output signal with comparatively large amplitude or selects, in accordance with the comparison result by the Duty comparison mechanism, the output signal with the Duty ratio comparatively near a predetermined value.

3. The communication apparatus according to claim 2, wherein
the signal selection mechanism determines whether to select the output signal in accordance with the comparison result by the amplitude comparison mechanism or to select the output signal in accordance with the comparison result by the Duty comparison mechanism based on a predetermined priority information for specifying the comparison result to be preferentially referred to between the comparison result by the amplitude comparison mechanism and the comparison result by the Duty comparison mechanism.

4. The communication apparatus according to claim 3, further comprising:
a digital conversion mechanism that converts the output signal output from the demodulation mechanism to a digital signal; and
a waveform shape mechanism that shapes the waveform of the digital signal output from the digital conversion mechanism, wherein
the amplitude comparison mechanism compares with each other the output signals output from the plurality of the demodulation mechanisms; and
the Duty comparison mechanism compares with each other the digital signal originating from each of the demodulation mechanisms output from the waveform shape mechanism.

5. The communication apparatus according to clam 1, wherein
the characteristics comparison mechanism compares the amplitude of the output signals as the characteristics; and
the signal selection mechanism selects, in accordance with the comparison result by the characteristics comparison mechanism, the output signal with large amplitude.

6. The communication apparatus according to claim 1, wherein
the characteristics comparison mechanism compares the Duty ratio of the output signals as the characteristics; and
the signal selection mechanism selects, in accordance with the comparison result by the characteristics comparison mechanism, the output signal whose Duty ratio is comparatively near a predetermined value.

7. The communication apparatus according to claim 1, wherein
the communication apparatus is a non-contact type IC card having a secure chip in which information is securely stored and a communication chip that executes the process of storing information in or reading information from the secure chip in accordance with a predetermined command obtained by using non-contact communication or a reader/writer transmitting the predetermined command to a communication device that has the function of the non-contact type IC card or receiving a response signal transmitted in response to the predetermined command.

8. A non-contact type IC card having a secure chip in which information is securely stored and a communication chip that receives from a reader/writer a command for executing the process of storing information in or reading information from the secure chip and executes the process of storing information in or reading information from the secure chip in accordance with the command, comprising:
a plurality of demodulation mechanism that demodulates in parallel multiple modulated signals obtained from a signal transmitted from the reader/writer;
a characteristics comparison mechanism that compares with each other, in a detection phase of synchronous codes of output signals output from the plurality of the demodulation mechanisms, the characteristics of the output signals; and
a signal selection mechanism that selects, in accordance with the comparison result by the characteristics comparing mechanism, the output signal having comparatively good characteristics.

9. A method of selecting a signal, comprising:
a demodulating step of demodulating in parallel, by a plurality of demodulation mechanisms, multiple modulated signals obtained from a signal transmitted in a non-contact communication;
a characteristics comparing step of comparing with each other, in a detection phase of synchronous codes of output signals output from the plurality of the demodulation mechanism, the characteristics of the output signals; and
a signal selecting step of selecting, in accordance with the comparison result of the characteristics comparing step, the output signal with comparatively good characteristics.

10. A computer program product having instructions that when
executed by a CPU perform steps comprising:
a demodulating step of demodulating in parallel, by a plurality of demodulation mechanisms, multiple modulated signals obtained from a signal transmitted in a non-contact communication;
a characteristics comparing step of comparing with each other, in a detection phase of synchronous codes of output signals output from the plurality of the demodulation mechanism, the characteristics of the output signals; and
a signal selecting step of selecting, in accordance with the comparison result of the characteristics comparing step, the output signal with comparatively good characteristics.
